(19) United States
(12) Patent Application Publication
(10) Pub. No.: US 2010/0013928 A1
(43) Pub. Date: Jan. 21, 2010

(54) IMAGE RECORDING SYSTEM

(75) Inventor: Karsten Haug, Stuttgart (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/922,162

(22) PCT Filed: Jun. 1, 2006
(86) PCT No.: PCT/EP2006/062806

§ 371 Date: Sep. 30, 2009

(30) Foreign Application Priority Data
Jul. 20, 2005 (DE) 102005033863.1

(51) Int. Cl. H04N 7/18

(52) U.S. Cl. 348/148; 348/E07.085

(57) ABSTRACT

An image recording system having a CCD camera or CMOS camera for picking up the surroundings of a vehicle. The image recording system additionally includes a radiation sensor for sensing a pulsed light source, as well as a control device, controlled by the radiation sensor, which determines the discrepancy between the exposure phase of the camera and the ON phase of the pulsed light source and minimizes it by synchronizing the exposure phase with the ON duration

### FIELD OF THE INVENTION

The present invention relates to an image recording system.

### BACKGROUND INFORMATION

An image recording system may be used, for example, in motor vehicles to obtain images of the vehicle surroundings and, in conjunction with assistance systems, to facilitate the driver in guiding the vehicle. In particular, such an image recording system also picks up vehicles which are moving in the same traffic lane or adjacent traffic lanes in front of the host vehicle. An image recording system of this type includes at least one image sensor and an optical system that is assigned to this image sensor and images a photo field of the vehicle surroundings onto the image sensor. A task of such assistance systems is the precise measurement of distance, since optical traffic-lane monitoring systems and vehicle-to-vehicle distance monitoring systems function only with sufficient reliability if precise distance values are known. Furthermore, such image recording systems are being used increasingly for a function called “Night Vision”, in which the scene illuminated by infrared high-beam headlamps is recorded via a camera also sensitive in the infrared range, and represented on a display for the driver in order to permit a greater visual range. The image sensors used in such image recording systems are usually CCD or CMOS cameras. Since these cameras do not expose continuously, thus during the complete frame phase, but only in certain time intervals (e.g., shutter time in the case of CCD cameras), there is the risk that pulsed light sources picked up by the image recording system will be distortedly represented. In this connection, distortedly represented means that the light sources are picked up and reproduced with too low an intensity, with too high an intensity or, in the worst case, are not picked up and reproduced by the image recording system at all. For example, the pulsed light sources may be brake lights or taillights of preceding vehicles implemented using LED technology, or oncoming vehicles having pulsed LED front lighting. The distorted representation comes about because the ON phases of the pulsed light sources do not coincide with the exposure phases of the camera. However, the faulty sensing and representation of the pulsed light sources can give rise to dangerous situations. One risk comes about, for example, because the driver of the host vehicle, upon glancing at his/her night vision display, no longer recognizes that the preceding vehicle is braking. At this point, there is a threat of a rear-end collision. When driving at night, preceding or oncoming vehicles cannot be recognized as well on the display, since the pulsed light sources are no longer clearly represented.

German Patent No. DE 100 33 103 A1 describes an infrared imaging system that has at least one IR light source and at least one IR display device for representing a relief able to be illuminated by the IR light source, an IR detector for recognizing an external IR pulse additionally being provided. This patent starts from the assumption that the indicated imaging systems are used in motor vehicles, and encountering motor vehicles are also equipped with them. The additionally provided IR detector detects interfering IR light pulses from another vehicle which could blind the imaging system of the host vehicle. Furthermore, the IR detector controls the inherent pulse frequency in such a way that it is adjusted to the external pulse frequency. For example, the adjustment is made in such a way that in the absence of an external IR lamp, the relief is illuminated the entire time, and if one or more external lamps are present, the radiating time of the IR system in the host vehicle is set so that a maximum illumination time remains.

U.S. Patent Application No. 2003/0043280 A1 also describes an image recording system having an infrared camera and an infrared lamp which illuminates the coverage range of the infrared camera. In addition, the image recording system includes a sensor which, upon detection of an external pulsed light source in the coverage range of the image recording system, controls the infrared camera in such a way that, to the greatest extent possible, the external pulsed light source is not picked up by the camera.

### SUMMARY

The present invention may permit substantially improved sensing of pulsed light sources, to thus improve the recognition of pulsed light sources and thereby to increase traffic safety. To this end, the image recording system may advantageously include a radiation sensor having generally identical intensity dynamics, having a generally identical opening angle and a generally identical direction of view as the camera, for sensing pulsed light sources. The image recording system also includes a control device which ascertains the discrepancy based on the signals from the camera and the radiation sensor. In one example embodiment, as a function of the discrepancy determined, a warning signal is generated which indicates deficiencies in the display representation to the driver. Additionally, the display may be controlled to the dark state temporarily, or perhaps switched off. In more complex embodiment variants, the exposure phase of the camera is synchronized with the ON phase of the light source as a function of the discrepancy. In another example embodiment variant, the image recording system is operated in a linear mode on one hand, and in a non-linear mode on the other hand. Recorded images are compared. In response to the appearance of pulsed light sources, at least partial areas of the images acquired in the non-linear mode are replaced by corresponding partial areas of the images acquired in the linear mode.

### BRIEF DESCRIPTION OF THE DRAWINGS

Below, the present invention is explained in greater detail based on the example embodiments shown in the figures.

FIG. 1 shows a block diagram of an image recording system.

FIG. 2 shows a block diagram for ascertaining the discrepancy.

FIG. 3 shows a first diagram with representation of the exposure phase of a camera and the ON phase of a pulsed light source.

FIG. 4 shows a further diagram with representation of the exposure phase of a camera and the ON phase of a pulsed light source.

FIG. 5 shows another diagram with representation of the exposure phase of a camera and the ON phase of a pulsed light source.

FIG. 6 shows a further diagram with representation of the exposure phase of a camera and the ON phase of a pulsed light source.

FIG. 7 shows another diagram with representation of the exposure phase of a camera and the ON phase of a pulsed light source.

FIG. 8 shows the representation of a controller which alters the exposure phase as a function of the discrepancy supplied on the incoming side.

### DETAILED DESCRIPTION OF EXAMPLE EMBODIMENTS

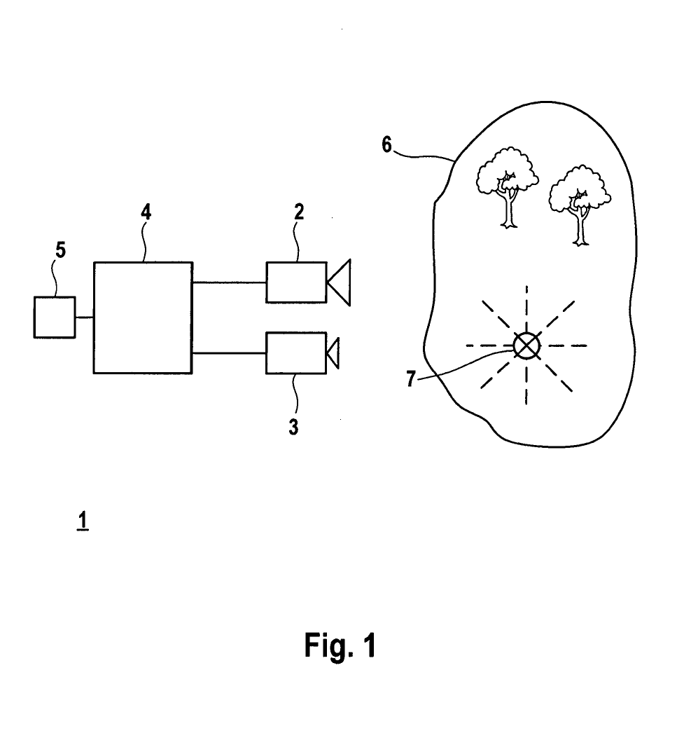

In the following, exemplary embodiments of the present invention are described. A first exemplary embodiment is explained with reference to FIG. 1, which shows a block diagram of an image recording system 1 and an image scene 6. Image recording system 1 includes a camera 2, in particular a CCD or CMOS camera. In addition, image recording system 1 includes a radiation detector 3 which has intensity dynamics corresponding to the greatest extent possible with camera 2, as well as the same opening angle and the same direction of view as camera 2. Radiation detector 3 is preferably a photodiode or a phototransistor. Camera 2 and radiation detector 3 are connected to a control device 4. Control device 4 is connected to a display 5.

Radiation detector 3 quasi continuously ascertains an average brightness level of entire image scene 6 which is picked up by image recording system 1. From the histogram of the camera image, which is formed for an exposure control, an average brightness is likewise formed by calculating back with the aid of the known exposure parameters for this histogram. If these two brightness levels deviate significantly from each other, it may be deduced that pulsed light sources 7 are in the coverage range of image recording system 1 which are not completely picked up by camera 2, since its exposure phase at least partially coincides with the dark phases of pulsed light sources 7. This situation is denoted hereinafter as discrepancy. In one example embodiment variant of the present invention, in response to the existence of such a discrepancy, a warning is output on display 5 of image recording system 1.

For example, this warning may prompt the driver to pay particularly close attention to the road, and to at least temporarily disregard the representation on display 5. In an alternative embodiment variant, possibly in conjunction with such a warning, display 5 may be switched off at least temporarily since it no longer correctly represents the surroundings of the vehicle, particularly pulsed light sources 7 present there.

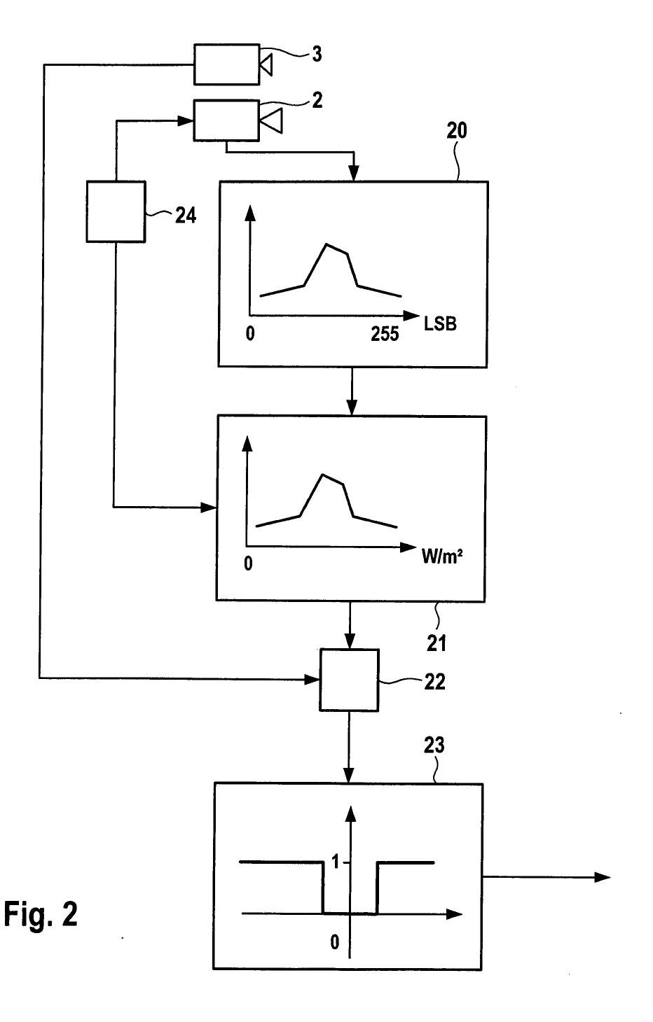

FIG. 2 shows a block diagram used to clarify the ascertainment of the discrepancy. Reference numeral 2 again denotes the camera of image recording system 1. Reference numeral 3 denotes an additional radiation detector. Camera 2 is connected to a function module 20. Function module 20 is connected to a function module 21. A function module 24 is connected to camera 2 and function module 21. Function module 21 is connected to a function module 22. Radiation detector 3 is connected to function module 22. Function module 22 is connected to a function module 23. Upon recording an image scene, a stream of video data is made available by camera 2. For example, the word length may be 8 bits. The video data of camera 2 is supplied to function module 20, which first of all ascertains a histogram of the digital gray-scale values from this video data. Taking into account the respective selected exposure parameters and operating characteristics of camera 2, such as the stop number and sensitivity of the imager (function module 24) used in camera 2, the histogram of the digital gray-scale values is then converted in function module 21 into a histogram of absolute brightness values. In a further step, an average value of the brightness is then determined from these brightness values, e.g., by integration. This average value is then compared in function module 22 to an average value of the brightness which has been sensed by additional radiation detector 3. Advantageously, the comparison may be carried out by forming the difference between the two indicated average values in function module 22. This comparison supplies the desired discrepancy. By specifying a threshold value, advantageously a binary form of the discrepancy may also be obtained. So long as the specifiable threshold value is not attained, the discrepancy assumes the value ZERO. If the specifiable threshold value is exceeded, the discrepancy assumes the value ONE.

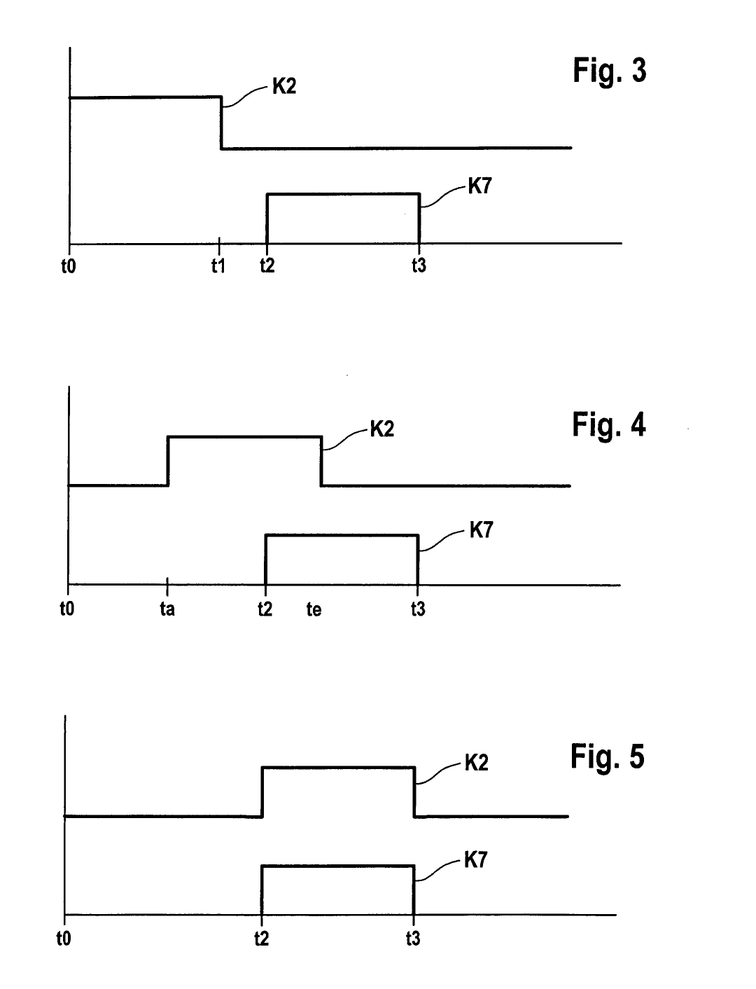

If image recording system 1 includes a camera 2 capable of a restart, in a further exemplary embodiment of the present invention, it may be attempted to shift the exposure phase of camera 2 in such a way that the exposure phase of camera 2 and the ON phase of pulsed light source 7 are synchronized in correct phase relation. This is clarified with reference to FIGS. 3, 4 and 5, each of which shows exposure phases (curve K2) of camera 2 and ON phases (curve K7) of pulsed light source 7. In FIG. 3, according to curve K2, the exposure phase of camera 2 begins at instant t0 and ends at instant t1. On the other hand, the ON phase of pulsed light source 7 begins at t2 and ends at t3. Since there is no temporal overlap, in practice this means that camera 2 does not pick up pulsed light source 7. The danger to road users resulting from this is obvious. In FIG. 4, according to curve K2, the exposure phase of camera 2 begins at ta and ends at te. The ON phase of pulsed light source 7 is again between t2 and t3. In this way, a temporal overlap results between the exposure phase and the ON phase in the interval t2 to te. Finally, FIG. 5 shows an optimized situation in which the exposure phase of camera 2 and the ON phase of pulsed light source 7 completely coincide, since both cover the time interval t2-t3. In this case, an ideal situation is assumed in which the duration of the exposure phase and the duration of the ON phase are generally of equal length. In practice, however, the exposure phase and the ON duration may be of different length. Therefore, the aim is for the exposure phase to cover the greatest possible portion of the ON phase. A camera capable of a restart does not operate in a fixed cycle, but rather, triggered by an external pulse, can be forced to record a new image. Preferably, the exposure phase of camera 2 is therefore initially shifted by one half frame duration. It is then calculated once more whether a discrepancy exists. Should this still be the case, the exposure phase of camera 2 is again shifted forward by one half frame duration. The measure described is repeated until the discrepancy becomes sufficiently small. Preferably a limiting value of the discrepancy may be predefined for this purpose.

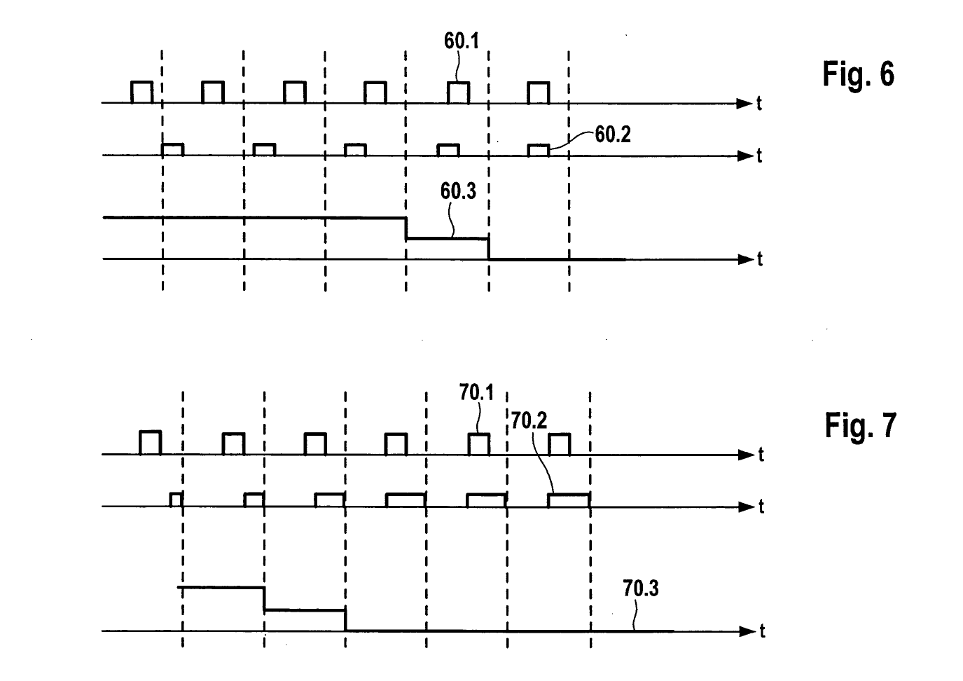

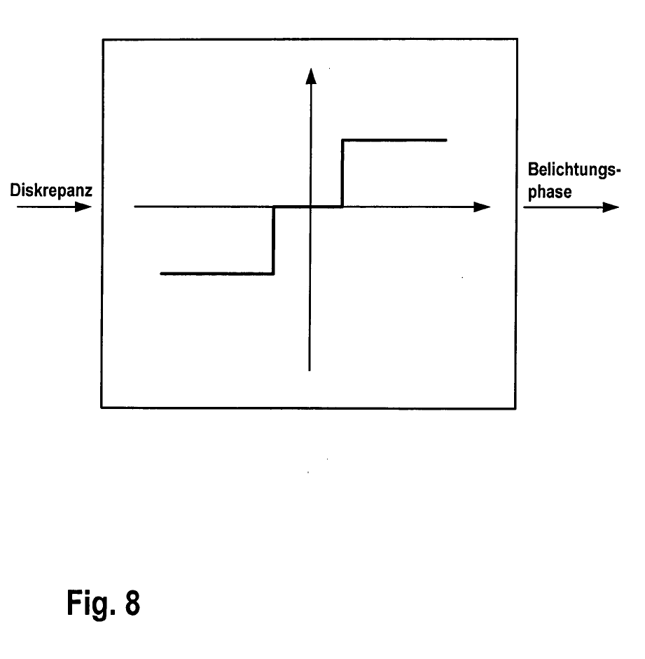

This relationship is explained again in the following with reference to FIG. 6, which shows a plurality of successive exposure phases. The exposure phases are separated from each other by the vertical dotted lines. The upper pulse-timing diagram denoted by reference numeral 60.1 represents the optical output signal of a pulsed radiation transmitter, e.g., an LED light source, which is controlled with a constant pulse repetition rate. The light-emitting duration is constant in each instance. Middle pulse-timing diagram 60.2 represents the exposure phases of camera 2 and of radiation detector 3. FIG. 6 now shows by way of example how a phase difference initially existing between the pulsed LED light source and camera 2, capable of a restart, is controlled. In this connection, capable of a restart means that the exposure times of camera 2 do not run in a fixed clock grid, but rather are variable as a function of time and, for example, are able to be triggered via a binary input. For instance, such cameras are also frequently used in production monitoring. The curve shape denoted by reference numeral 60.3 represents the discrepancy. As discernible in FIG. 6, the pulsed light source (pulse-timing diagram 60.1) and the exposure phase (pulse-timing diagram 60.2) of camera 2 initially have a phase difference of approximately 180°, thus, they are virtually in phase opposition. Therefore, the discrepancy (curve 60.3) is clearly positive, and thus leads to a positive phase shift in the three-position controller shown in FIG. 8. The existing phase difference is corrected within four camera cycles. Instead of a three-position controller, a PI-, PD-, PID-controller or any suitable control strategy could be used as well.

In another example embodiment variant of the present invention, a camera 2 is provided which is not capable of any restart. Cameras of this kind are relatively widespread. In this embodiment variant, the exposure time of camera 2 is altered in such a way that the ON phases of pulsed light source 7 are completely detected. To that end, first of all there is a switch to maximum exposure time, which corresponds to the frame duration. Additionally, camera 2 is switched over from a non-linear to a linear photographic mode. This means that no unexposed phases come about due to a non-linear knee characteristic curve. At the same time, the amplification is reduced in order to keep an overexposure in bright areas of the coverage range of camera 2 as little as possible. These measures ensure that pulsed light sources 7 are completely detected. The image thus obtained is calculated back to absolute brightness and compared with the previously recorded, likewise calculated back but not completely exposed image. Significant differences between the two images are apparent at the places at which there are pulsed light sources. These places are then replaced in the original image by the intensities ascertained in a linear photographic mode, which means pulsed light sources are now also picked up and become visible in their actual intensity.

This relationship is explained again in the following with reference to FIG. 7. Pulse-timing diagram 70.1 again represents the optical output signal of a pulsed radiation transmitter, particularly an LED light source. Pulse-timing diagram 70.2 represents exposure phases of a camera incapable of a restart. For example, it is a classic CCD or CMOS camera whose exposure phases are always at the end of a camera cycle immediately prior to the readout time. Thus, it is not possible to shift the end of the exposure phase. Only the length of the exposure phase may be altered. The discrepancy (curve 70.3) is again used as input variable for a controller, e.g., a three-position controller according to FIG. 8. However, as in the previously described example of a camera capable of a restart, other controller types may be used as well. As is shown in FIG. 7, at first the active control phases of the LED light source (pulse-timing diagram 70.1) and of the camera incapable of a restart (pulse-timing diagram 70.2) do not overlap at all. Therefore, the discrepancy initially assumes a relatively large positive value (curve 70.3). In the controller (FIG. 8), this leads to an extension of the exposure time, accompanied by simultaneous reduction of the gain of the camera. The absolute amplification of the camera (approximately the product of the exposure duration, gain and a constant) is thus not changed. However, in this instance, the motion blur and the noise level of the camera increase. In the third of the camera cycles shown in FIG. 7, an overlapping takes place for the first time, with the result that the discrepancy (curve 70.3) diminishes. In the fourth camera cycle, the discrepancy was finally completely corrected. The LED light source is now completely detected in its true light intensity.

In the event the host vehicle is equipped with pulsed front headlights (e.g., with LED or laser headlights) which are synchronized with the exposure phases of the camera, then the illumination phases of the front headlights in the host vehicle are also shifted, analogous to the exposure phases of the camera.

1-10. (canceled)

11. An image recording system, comprising:
a camera adapted to pick up surroundings of a vehicle;
a radiation sensor adapted to sense a pulsed light source; and
a control device, controllable by the radiation sensor, adapted to determine a discrepancy between an exposure phase of the camera and an ON phase of the pulsed light source.

12. The image recording system as recited in claim 11, wherein the camera is a CCD camera or a CMOS camera.

13. The image recording system as recited in claim 11, wherein the camera is a camera capable of a restart.

14. The image recording system as recited in claim 11, wherein the radiation sensor has generally identical intensity dynamics, a generally identical opening angle and a generally identical direction of view as the camera of the image recording system.

15. The image recording system as recited in claim 11, wherein upon occurrence of a discrepancy, at least one of a display of the image recording system is switched off, and a warning signal is output.

16. The image recording system as recited in claim 11, wherein upon occurrence of a discrepancy, the exposure phase of the camera is synchronized with the ON phase of the light source.

17. The image recording system as recited in claim 11, further comprising:
a controller to which the discrepancy is able to be supplied as an input variable.

18. The image recording system as recited in claim 11, wherein the exposure phase of the camera is altered as a function of time until a specifiable limiting value of the discrepancy is reached.

19. The image recording system as recited in claim 16, wherein for the purpose of synchronizing the exposure phase of the camera with the ON phase of the light source, the exposure phase is initially shifted by one half frame duration, and the ensuing discrepancy is then determined.

20. A method of operating an image recording system, the image recording system including a CCD camera or CMOS camera adapted to pick up surroundings of a vehicle, the method comprising:
operating the image recording system in a normal, non-linear mode, and acquiring at least one image from a coverage range of the image recording system in the normal, non-linear mode;
operating the image recording system in a linear mode, and acquiring at least one image from the coverage range of the image recording system in the linear mode;
comparing the image acquired in the non-linear mode and the image acquired in the linear mode; and
in response to an appearance of pulsed light sources in the images, at least partial areas of the image acquired in the non-linear mode are replaced by corresponding areas of the image acquired in the linear mode.
